(19) United States
(12) Patent Application Publication
(10) Pub. No.: US 2005/0119941 A1
(43) Pub. Date: Jun. 2, 2005

(54) Medical after sales support

(75) Inventor: Roger James, Cambridgeshire (GB)

Correspondence Address: DAVIDSON, DAVIDSON & KAPPEL, LLC, 485 SEVENTH AVENUE, 14TH FLOOR, NEW YORK, NY, 10018, US

(73) Assignee: Euro-Celtique S.A., Luxembourg (LU)

(21) Appl. No.: 10/498,931

(22) PCT Filed: Nov. 27, 2002
(86) PCT No.: PCT/GB02/05373

(30) Foreign Application Priority Data
Dec. 12, 2001 (GB) 0129767.0

(51) Int. Cl. G06F 17/60

(52) U.S. Cl. 705/26

(57) ABSTRACT

A system of providing medical after sales support to a patient or other user associated with a patient having a packaged medical product with a product code identifying the product is disclosed, wherein the user remains anonymous. A product code and a user identifier or contact address are received at a medical information computer (3) over a communications link (2,5) from a user (1,4). The received code is verified to determine if it corresponds to a valid code stored in a product code database (3e). The received user identifier/contact address is verified to determine if it corresponds to a valid user identifier/contact address stored in a user identifier/contact address database (3f). Information related to the packaged medical product identified by the product code is retrieved from a user medication record database (3h) or product information database (3g), upon positive verification. The retrieved information related to the packaged medical product is outputted over a communications link (2,5) to the user (1,4) identifier/contact address. The system can allow the building of a user managed anonymous medication record, and can allow anonymous personal verification of individuals receiving medical treatment.

This invention relates to the provision of medical after sales support to a patient or to someone associated with a patient, such as a carer, pharmacist, relative or doctor, for a patient undergoing or prescribed for treatment with a pharmaceutical drug, medicament, medical device or other medical product.

A person in need of treatment (‘patient’) with a medical product, for example a drug or medicament, typically purchases or obtains a relevant drug or course of drugs from a pharmacist, doctor or high street chemist, either following prescription by a qualified medical practitioner or directly over-the-counter.

The drug is generally contained within suitable packaging, such as a box, bottle, jar, packet, sachet, dispenser, wrapper, bag or phial. The packaging generally displays relevant product information on an exterior surface, for example printed directly on the packaging or on a label adhered to the packaging, or may be contained within the packaging, for example on an information leaflet enclosed within external packaging such as a cardboard box. The drug is generally removed from the packaging before the drug is consumed, injected or otherwise administered to treat the patient. The drug may be supplied in packaging by the drugs manufacturer or distributor, or may be dosed into appropriate packaging, by a pharmacist for example, from a larger stock of drugs supplied by the drugs manufacturer or distributor.

Similarly, a patient may be in need of treatment with a medical product that is or includes a physical device or product, for example an inhaler or nebuliser for treatment of asthma or hayfever, a surgical implant, or contact lenses for eyesight correction, and the product is purchased or otherwise obtainable in appropriate packaging. Again, the product is usually removed from the packaging before it is used to treat the patient.

It would be desirable to be able to provide a rapid and convenient after sales support service to a patient using a drug or other medical product. It would be desirable for a patient to be able to obtain information concerning the product, for example its efficacy, any contra-indications and side effects, and for general advice and support in matters relating to the treatment with the product, in a convenient manner. It would also be desirable for the manufacturer of the medical product to be able to provide information concerning a drug or other product, that has been purchased by or for a patient, selectively to patients undergoing treatment with the product, or to persons associated with the patient such as a carer, pharmacist, relative or doctor. Moreover, it would be desirable for a patient or associated person to be able to obtain the information anonymously, without having to reveal their identity.

General product information concerning a drug or other medical product can be supplied with the product in an accompanying information leaflet, or printed on the packaging. However, this route provides little scope for the provision of after sales support to the patient. Of course, a patient or carer wishing to learn more about the product or treatment can contact his doctor by appointment, or may contact the manufacturer by a telephone helpline, for example. However, these methods are not always convenient to the patient, doctor or manufacturer.

Furthermore, once a medical product has been purchased to treat a patient, it may be difficult or inconvenient for the patient, carer or doctor to monitor the subsequent use of the product in the treatment of the patient. For example, it may be difficult to ascertain whether the patient is complying with the prescribed course of drugs treatment according to the dosage and regime recommended by the manufacturer or doctor for a particular drug, if the drug is being self-administered by the patient or administered by a carer or relative. Consequently, for example, a patient or carer may inadvertently deviate from administering the optimum dosage, or may simply forget to adhere to the recommended treatment regime. In certain treatments, the compliance with dosing or drug regimes is a conditional part of treatment. For example, schizophrenia patients' treatment by antipsychotics and release on licence may be conditional on their compliance with the treatment. Similarly, multiple sclerosis sufferers' continuing treatment with beta-interferon may be conditional on their compliance with the prescribed treatment regime, for NICE Provisional Appraisal Determination. In the former case, the continuing terms of the licence demand compliance, whilst in the latter case, demands for reimbursement for the treatment call for a detailed and accurate record of compliance.

It is known for patients or third parties nominated by a patient to receive prescription compliance reminders, on a pager, cellular phone, digital organiser or landline telephone, in the form of text or voice messages, according to choice, from a commercially operated Internet-based prescription reminder service. To enrol with the service, the patient or patient's doctor must communicate the patient's identity, a contact address and prescription details to the service operator, and the service operator then sends periodic reminder messages to the patient or third party to promote compliance with the prescription details. However, the information provided by the patient or doctor for enrolment, whilst identifying the patient such that the reminders can be sent to and received by the patient, does not allow identification of the particular drug product, or of the batch to which the drug product belongs, unless specifically communicated by the patient or doctor, and does not allow the patient to remain anonymous to the service provider. Moreover, current practice does not allow for individuals and receivers of care to be independently verified. This would be important in controlling access to medications outside of the doctor-patient relationship.

A patient or carer may be unaware or forget that their stock of the drug or other product is about to be used up, thus running the risk that the stock runs out without a fresh supply having been obtained. Moreover, if a patient has purchased a stock of a product having a limited lifetime, a patient or carer may inadvertently continue to use product from their supply that has exceeded its expiry date.

Thus, it would be desirable for a patient or carer to be able to receive periodic reminders relating to the treatment with the product, or to receive other notifications relating to the product. Moreover, it would be desirable for the patient to be able to receive reminders or notifications whilst remaining anonymous. Furthermore, it would be desirable to be able to provide a mechanism for establishing anonymous proof of identity in controlling access to or dispensing of medications.

We have now found that it is possible to achieve at least some these aims by the method and apparatus of the present invention.

According to the present invention, a patient, or a carer for a patient, or other persons concerned with the treatment of a patient (herein referred to as ‘users’) can gain access to after sales support for a drug or other medical product by registering a code that accompanies the product, for example a code printed on the packaging of the drug, whilst remaining anonymous. The code may be applied to the packaging, or in the packaging, or even to the product itself, in any suitable manner, by the manufacturer or authorised agent of the manufacturer, for example by printing, stamping, laser etching, punching or label adhesion.

The present invention is applicable to any medical product intended to be used for treating a patient, and which is sold in or as a packaged product. What is important is that the code should accompany the medical product as purchased by or supplied to the user, so that the code is associated with the particular medical product that has been purchased.

In one embodiment, the code is applied on or in the packaging or product so as to be visible from the outside of the packaged product, without the packaging having to be opened. However, in certain applications, it may be desirable for the code to be applied within the packaging, so that it becomes visible only once the packaging has been opened. For example, in another embodiment, one or more codes are applied within a blister pack that contains individual doses or measures of a drug for a course of treatment, and each code only becomes visible when each blister pocket is opened. Thus, the codes become readable only when the treatment starts and a first blister pocket is opened, or as the treatment progresses and the blister pockets are progressively opened. The codes within the blister pack can, if desired, be combined with another coded portion provided on the outside of the pack, so as to form a combination product code.

The medical product will be associated with packaging appropriate to the product, for example a box, bottle, jar, packet, blister pack, sachet, dispenser, wrapper, bag or phial. It will be appreciated that no special apparatus or technology is required beyond conventional packaging of medicines. The code is applied, preferably in plain text, and is visible once the pack is purchased, once the pack is opened or once an individual blister pocket is opened. In the case of devices such as asthma inhalers, the code can be included as part of the overall package.

Suitable medical products include pharmaceutical drugs, medicaments, and medical devices such as inhalers, nebulisers, surgical implants and contact lenses. Also included are programmable devices such as asthma inhalers (e.g. AirWatch™, in which user patients breathe into a monitor that records key asthma parameters. The monitor automatically uploads the data via modem to a website server, where the data is processed to highlight asthma triggers and trends for the patient. Patients and their authorised healthcare professionals can then access the data on a secure website).

The product code associated with the packaged product serves to identify the product to the manufacturer, who will have assigned to each product or to a group of products a corresponding code, and stored the list of codes against their corresponding products as records in a product code database. Information related to the product can then be made available to the user of the product whilst the user remains anonymous to the manufacturer. If desired, part of the code can be code that has been added, such as by overstamping, at one or more stages during transit of the packaged product from the manufacturer to the point of sale or dispensing, for example by a distributor, doctor or pharmacist, so as to record additional information about the product. For example, the additional information in a concatenated product code of this type could include a code representing the dispensing outlet, or patient's or pharmacist's geographical location, for example a postcode area.

In one embodiment, the code is such as to uniquely identify an individual packaged product, so that the code read from any particular package would enable the manufacturer to ascertain from records that that particular individual product was concerned. For example, if the packaged product is a box containing a number of drugs capsules, a code on the box might identify to the manufacturer such information as the type of drug, the dosages, their form as capsules, the number of capsules in the box, and the expiry date.

In another embodiment, the code is such as to identify one of several identical, individually packaged doses of a drug, so that information related to the individually packaged dose could be ascertained from records. For instance, in the above example, a code provided with each drugs capsule would allow a manufacturer to identify a particular capsule in the box, and the number of capsules originally in the box, as well as the type of drug, dosage and expiry date of the capsules in the box. If the codes are reported individually to the manufacturer as and when each corresponding capsule is consumed, the manufacturer can determine how many capsules are remaining in the box at any given time. The qualitative, numerical or temporal information provided by the reported codes, or a combination of these, can then be used for example to generate automatically a refill reminder for the user to replenish their supply before the supply runs out, or a warning for the user that the expiry date is imminent or exceeded. The information can also be captured to provide statistical information about the pattern of drug usage by the user, and thus form a medication record for the user.

In another embodiment, the code is such as to identify a group of identical packaged products, so that the code read from any particular package would enable the manufacturer to ascertain from records that the package concerned was one from a group of identical packaged products, for example a batch, stock or other plurality of packaged drugs. For example, the manufacturer would be able to determine that a particular box of drugs capsules having a code on the box belonged to a particular production batch, from the code.

Thus, the code serves as an identification means in providing the manufacturer with information that allows him to identify either a particular product uniquely or a plurality of products such as a batch. Knowledge of the code allows the manufacturer to determine from records in a product code database what the drug or other medical product is, and consequently provides a means whereby the manufacturer can provide specific information about the particular product or batch concerned, or more general information relevant to treatment using the type of product concerned. This information is desired by the user of the medical product, following purchase of the product. Moreover, reports of the codes by users to the manufacturer allow the manufacturer to gather information about users' patterns of use of the products, and enables the manufacturer to target specific information to a user that is relevant to the user's needs. Thus, a mechanism is provided which allows the product to be identified.

When a product code is initially reported by a user to the manufacturer, the manufacturer obtains or assigns an electronic user identifier or contact address for the user, and stores the user identifier or contact address in a database. However, the user's personal identity remains anonymous to the manufacturer, as explained further below. Once a user has provided or been assigned with a user identifier or contact address, and the user identifier/contact address is stored, information related to the product identified by the reported product code can be made available to the user by the manufacturer, by sending the information to the contact address or providing access to the information through the user identifier.

The user identifier can be, for example, an anonymous login, a web cookie, a mobile phone or pager identity, an anonymous e-mail address, or a secure anonymised patient identifier such as an encrypted NHS number. In each case, the identifier acts as a reference point or message address such that a) messages can be sent to and received from the address, and b) the address can be used as the master record in a database schema used to record the longitudinal medication record.

The user identifier or contact address is stored by a web host for the manufacturer, and provides a contact point or gateway between the web host and the user of a packaged product having an associated product code. By comparing a code reported by any person with a code stored by the web host in a product code database, to determine whether the reported code is a valid code, the web host can identify the product and retrieve information about the product from stored records. When a user reports a product code to the web host over a communications link, the web host receives with the code a user identifier, such as an assigned login number or password, or contact address such as a mobile telephone number or e-mail address. The received user identifier or contact address is compared with the stored user identifiers/contact addresses to determine whether it is valid. If it is valid, the web host outputs the retrieved information relating to the product, as identified by the reported product code, to the contact address or user identifier access point. Thus, the manufacturer or web host can restrict access of, or selectively target, information relating to the product associated with a particular code to verified purchasers or other users of the medical product associated with the code.

In operation, a user of a purchased drug or other medical product desiring to obtain information relating to the drug reads the code from the package and transmits the code over a communications link to an information computer provided by or on behalf of the medical product manufacturer, for example a web host. The code may be read and entered by the user by any suitable means. For example, the code may be read visually and punched manually into an appropriate interface such as computer keyboard or telephone keypad, or could be read visually and spoken into a telephone, or may be read and entered using a scanner or other electronic reading device.

The code may be transmitted to the web host by any suitable means over a communications link, for example from a mobile or landline telephone either verbally or as tone dialled keypad entries, or as text in an SMS (Simple Messaging Service) or e-mail message or as web page input data from a mobile telephone, personal digital assistant, electronic organiser, personal computer or other electronic computer device. For codes verbally entered by telephone, voice recognition software may be used to convert the verbal code to electronic form.

The communications link is preferably an electronic link or network, preferably comprising the Internet or an extranet. However, if the code is transmitted in the form of an SMS or similar text message, or as tone dialled or voice-recognised telephone entries, or as WAP (Wireless Application Protocol) page input data, the communications link may include a wireless telecommunications link so as to allow the code to be transmitted to the medical web host through a telecommunications interface.

The contact address generally accompanies the product code when the code is transmitted to the web host. For example, if the code is transmitted in an e-mail message to the web host, the sender's e-mail address is transmitted simultaneously and can be stored by the web host, on receipt, in a contact address database. Similarly, if the code is transmitted in an SMS message, or tone dialled or voice-recognised entries from a mobile telephone, the telephone number will be received by the web host at the same time and can be stored in the contact address database.

Alternatively, if the code is transmitted as web page input data, on receipt of the code the web host server may output a cookie or similar data file to be stored on the user's computer as a user identifier, or may output a login number or password to the user's computer as a user identifier. The user identifier assigned to the user or the contact address for the user, stored in a user identifier or contact address database by the web host, serves both as a contact point for interaction between the user and the web host, and as an anonymous identification for the user. Once a user identifier/contact address has been stored for a user, subsequent receipt of a valid product code by the web host from the same contact address or with the same user identifier can be recognised by the web host as originating from the same user, by comparing the received user identifier/contact address with those stored in the user identifier/contact address database. Since the user at no stage has to reveal their personal identity, the user can remain anonymous to the web host.

Measures to protect the identity of the patient and to manage the patient record in the event of a loss of mobile phone or change of computer can be introduced as follows:—
Because of the nature of the collected data and the mechanism of security access, preferably no data on the system can be deleted. New associations to existing threads of data can be introduced and access models changed but preferably the primacy of the raw data will, in all cases, be applied. In the case of data privacy or requests for the disposal of records, positive identification can be required;
Medication records established by medical professionals can be accessed through existing access paths, for example via a BMA (British Medical Association) number/password, or through a secure anonymised identity such an encrypted NHS (National Health Service) number;
Medication records identified with anonymous contact points, for example mail identities or web cookies, will preferably require a PIN or password for changes to access or requests for data;
Medication records identified against devices, for example a mobile phone or pager number, will preferably use caller line identification to validate data input. Changes to data records or access will preferably require a PIN for verification. Switching phones will preferably require a PIN and some other collateral if not issued from the originating device.

Once the web host has established an anonymous identification for the user, by having stored a user identifier or contact address for the user, the web host can build up a medication record for the user, based on the information represented by the product codes received from a valid user identifier/contact address, and on the timing of the receipts of those product codes. Thus, for each anonymous user, a medication record is stored in a user medication record database. On receipt of the code by the medical web host, the received code is compared with product codes stored in a product code database. If the received code corresponds to a valid product code, whereby the received code is positively verified as being a genuine code associated with a purchased medical product, the web host can retrieve information, relating to the product concerned, from a product information database. The retrieved product information relates to the medical product as identified by the product code received from the user over the communications link. If the received code is found not to correspond to a stored product code, whereby verification is negative, the user may be denied access to stored data, and may be asked to re-enter a correct code. If the received code is not accompanied by a user identifier or contact address that has been stored by the web host, the web host may assign a new user identifier to the user, or store the accompanying contact address as appropriate. If desired, a registered anonymous user can provide one or several additional contact addresses.

Only if a positive verification is obtained for the product code and for the user identifier/contact address received at the medical web host is the user permitted to download or access data relating to the product from the web host. It will be appreciated that the order of verifying the product code and verifying the user identifier or contact address may be reversed, or may be conducted in parallel.

On verifying that a product code received by the web host over a communications link is valid, and that the user identifier or contact address associated with the received product code is valid, the web host can retrieve, from a product information database, information specific to the packaged medical product identified by the code. The types of product information that might be retrieved and outputted to the user include details about the medical product purchased by the user, or general medical information about medical treatments of possible interest to the user and relating to the type of product identified by the product code.

Alternatively, or in addition, the web host can retrieve, from the user medication record database, information specific to the user's usage of one or more medical products or combinations of medical products identified by codes received from the user. This information can include the user's history of medication with one or several medical products, each with associated product codes received from the user by the web host. In addition, the web host can store, in the user medication record database, information specific to the user's usage of one or more medical products based on the codes received from the user.

The web host may further comprise means to permit the secure editing, access management and sequence association of information specific to the user's usage of one or more medical products based on the codes received from the user, which allows a composite medication record to be assembled from entry through multiple access channels (e.g. via mobile phone, voice response, and web page entry channels). In this case, the storing means further comprises record assembly means for assembling information representing record fragments and received through different access channels into a composite medication record. Thus, if a user changes his mobile phone or alternatively uses web page entry or a PDA to enter information representing elements of his medication record, a composite master record can be built up from the various fragments.

If desired, each record fragment can remain structurally attached to the source channel, whilst the assembly means links all the fragments to provide a composite master medication record for the individual user. Thus, the storage means stores each record fragment associated with its access channel, whereby stored information representing a user medication record or record fragment is retrieved and outputted to the received user identifier/contact address only after receiving user's consent as positive verification through the access channel associated with the record fragment. In this embodiment, it is possible to use a ‘challenge/response’ technique, in line with patient privacy directives, whereby elements of the medication record can only be accessed by patient control. For example, in order to read the records linked to a mobile phone, positive confirmation from the mobile phone channel that access is allowed can be required before access to those records is granted. Thus, user consent is required for visibility to all or part of the medication record. This embodiment further allows the keying and access to the medical record via a master key, for example an encrypted NHS number.

In a preferred embodiment, the user downloads an information page from the medical web host, for example a web page, using a mobile telephone or computer, and enters the code as input data in response to a prompt displayed in the web page. The web host address may conveniently appear on the packaging for the drug or other medical product, for example as a web site address Uniform Resource Locator (URL)). The code is then transmitted by the user over a communications link to the web host as web page input data, and received at the web host or other information computer.

In another preferred embodiment, the web host address appears on the packaging for the drug or other medical product as a telephone number. On dialling and making of a telephone connection, from a mobile or landline telephone, the user enters the code read from the packaged product, for example in response to a pre-recorded verbal message provided by or on behalf of the web host. In response, the code is entered by the user either verbally or manually as tone dialled keypad entries. Appropriate software converts the verbally or manually entered code to electronic form and transmits the code to the web host or other information computer.

As mentioned, upon positive verification the user may access information from the web host. For example, the information may be accessed by downloading information pages from the host web server to the user's web browser, as web pages or other displayable data files.

The contact address is preferably a user's e-mail address or a user's mobile telephone number representing an SMS address, so that product or patient related information may be transferred to a specified user as an e-mail message or an SMS message. In the case of an impersonal identity, for example a mobile phone number, a ‘trapdoor’ encryption algorithm will preferably be used to protect the true identity of the access phone number. Entities such as pharmacists wishing to send a text message to the device will only know of the system identity (e.g. 12345678), which the system will resolve to a telephone identity (e.g. 07808 234567). Thus, the encryption ensures that the telephone number is not revealed to recipients of information from the medication record or issuers of patient information. Of course, plain text messages can be sent to and from the anonymous device requesting specific actions under the control of the agent at each end—for example “ring me for advice on this medication”.

Alternatively, the contact point is provided by a user identifier such as a PIN (Personal Identification Number), a password, or a login name. The PIN/password/login may be received from the user following a request by the web host, or generated by the web host and communicated to the user by the web host. If desired, the user identifier can be provided as a short code login comprising a telephone number for the web host followed by a short PIN. The product related information may include, for example, information specific to the patient for treatment by the product, information specific to a prescribed course of treatment for the patient with the product, a reminder message for the user for complying with the course of treatment prescribed for the patient with the product, a reminder message for the user for refilling or renewing stock of the product for the patient, or a product recall or other product alert message.

In one such embodiment, information related to the product or patient is periodically transferred to the patient or other user at the contact address. For example, a reminder message may be sent periodically to warn the patient or carer that their supply of a drug or other medical product will shortly run out, or will run past its expiry date, and to remind the user to purchase a fresh supply. In addition, or alternatively, periodic reminder messages may be sent to remind a user to comply with their treatment prescription.

In a further embodiment, polypharmacy information provided by product codes reported by a user of more than one drug is used by the web host to send dosing reminders to the user, to prevent misadministration and prevent iatrogenic adverse events. Similarly, in chronopharmacy applications, specifically timed reminders from the web host can be sent to users that use a timed drugs regimen of one or more drugs, based on the product codes as reported by the patient or other user. For example, cancer patients undergoing chemotherapy can be individually reminded to take painkiller, anti-emetic, appetite suppressant, chemotherapeutic agent, and laxative drugs at the optimum time of the day/night or week. Likewise, HIV sufferers undergoing combination therapy with several drugs can be reminded to administer the correct drugs, together or in sequence, at the most appropriate time, thereby maximising the likelihood of compliance with the optimum treatment regime. The information provided by the product codes allows the web host to cease sending reminders automatically, on dose-based expiry of the treatment.

If desired, the medical web host server can be further configured to transfer a cookie or other such user related data for storage by the user's web browser program on the user's computer, for statistical purposes or in order to facilitate subsequent interaction between a user and the medical web host. Similarly, the programmable features on certain telephones can be used to pre-configure the patient's device with ‘hot buttons’, e.g. for ‘talking protocol™’.

In another embodiment, the medical web host is additionally configured to receive an access code from a medic such as a doctor, medical consultant or pharmacist. The medic will have registered with the host, and been provided with a personal access code stored in an access database linked to the medical web host. The medic may transmit the code to the medical web host over a communications link by any suitable means, for example by means as explained above in relation to the patient and other users. On receiving the code over a communications link, the medical web host compares the received access code with access codes stored in an access database to determine whether the received access code is valid. If the received code is verified as valid, so as to authenticate the sender as a registered medic, access to information from the medical web host, for example product, patient and/or medical information, is granted to the medic.

In another embodiment, the identity device, telephone or pager, is used to validate the individual receiving treatment or a course of treatment. By identifying a prescription with a device, validation that the prescription is issued to the correct person is possible. Thus, a doctor can issue a secret codeword to the phone or pager and a pharmacist can check that this codeword presented on the phone or pager matches the code sent through an alternative secured physician-to-pharmacist system. Similarly by recording the prescription history against the anonymous patient identity, patterns of repeat prescription, especially for controlled drugs, can be managed and abuse identified.

In another embodiment dealing with the case where the patient does not have a mobile device or form of identity, a pager can be mandated as part of the prescription process to be used as described above. For controlled drugs, a scheme of loan pagers could be used for all dispensing and, where these pagers are lost, recourse to a central issuing authority for replacements can be made in order to manage the identity of the patient.

The medical web host may be further configured to receive information from the medic and store the received information in a database linked to the medical web host, for example in a product information database, patient records database and/or medical information database. Thus, a medic can update the information stored by the medical web host in one or more databases, or can make available or restrict selected information to relevant users of a relevant medical product.

Moreover, the medical web host may be further configured to transfer data received from the medic to a user. For example, the system may be configured to enable users to pose specific questions for a medic through the medical web host, to which a registered medic can then reply personally, again through the medical web host, over a communications link. If desired, any questions and replies between a particular user and medic could be made available to other users being treated with the same medical product, or any other users to whom the information might be of interest.

The present invention can be implemented on any suitably programmed computer system. Thus, the present invention can be embodied as computer program code provided on a suitable carrier medium to a computer to configure the computer to implement the invention. A suitable carrier medium can comprise a storage medium such as a floppy disk, CD-ROM, or programmable memory device, or a transient carrier medium such as an electrical, optical, microwave or radio frequency signal, for example a signal carrying the computer code over the Internet.

The present invention may be further illustrated by reference to the drawings, in which:

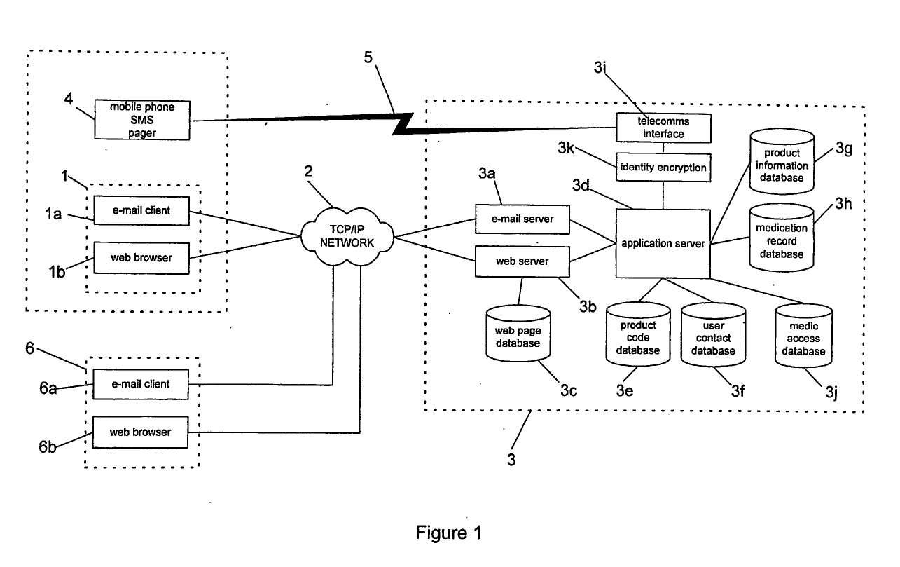

FIG. 1 represents a schematic diagram of a computer network for an after sales support system according to an embodiment of the present invention;

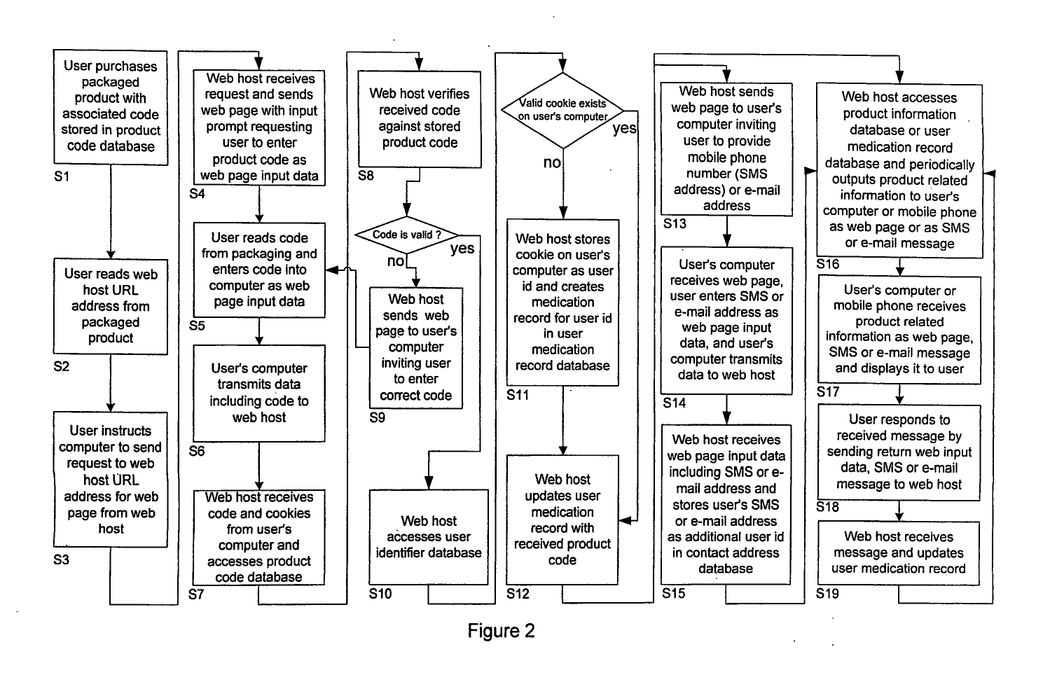

FIG. 2 represents a schematic diagram of operational steps for an after sales support system according to an embodiment of the present invention;

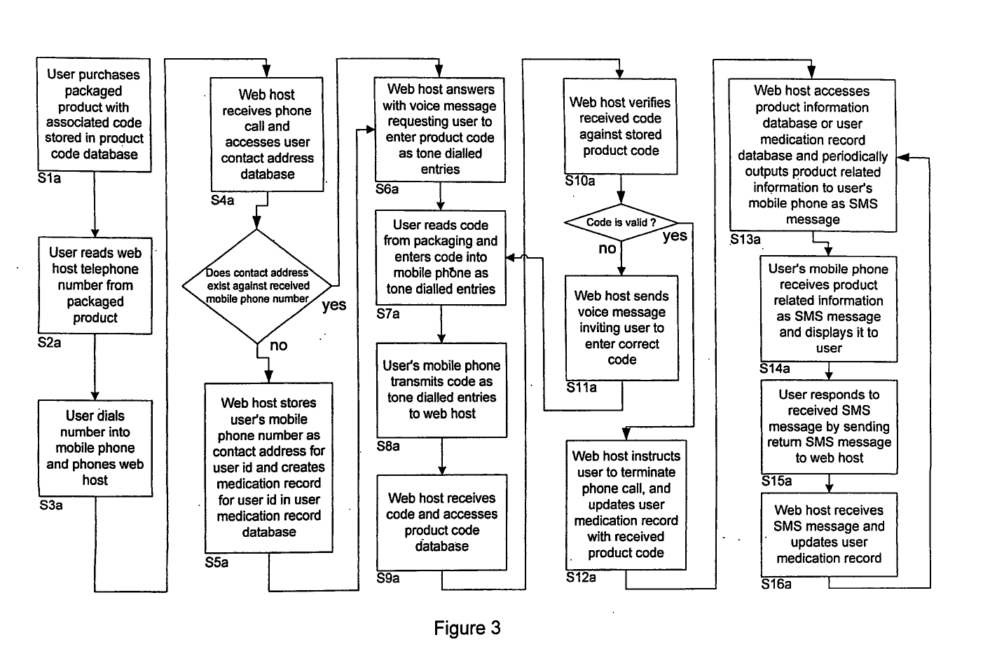

FIG. 3 represents a schematic diagram of operational steps for an after sales support system according to an embodiment of the present invention; and

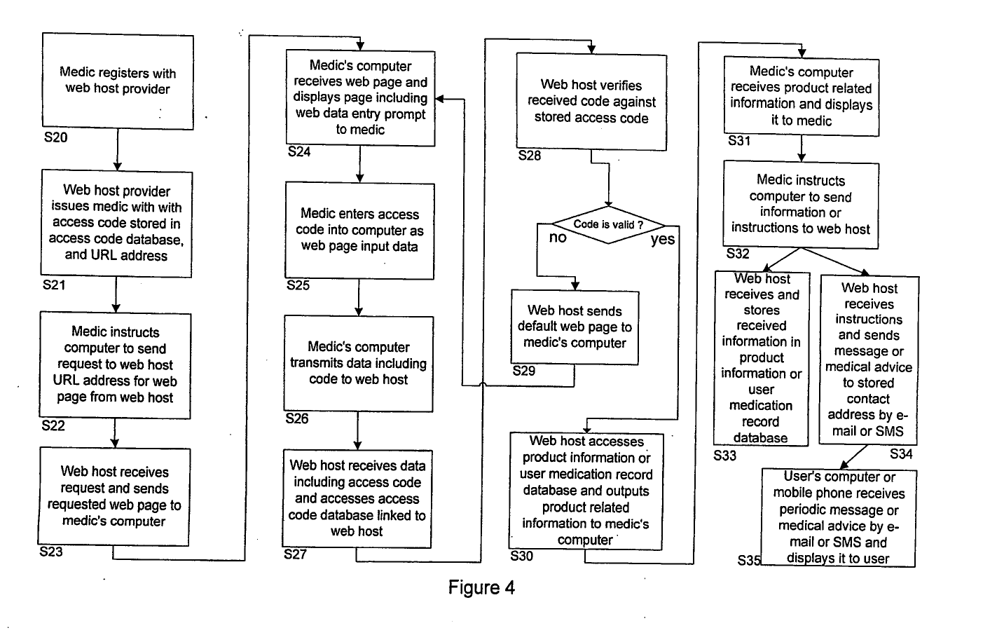

FIG. 4 represents a schematic diagram of operational steps for access of a medic to an after sales support system according to an embodiment of the present invention.

In a preferred medical support system as shown in FIG. 1, a user, for example a patient, gains access to after sales support by using a computer (1), such as a personal computer or laptop computer. The computer is programmed with a suitable e-mail client program (1a) such as Microsoft Outlook®, and web browser program (1b) such as Microsoft Internet Explorer® or Netscape Navigator®. When the user's computer (1) is connected to a TCP/IP network (2) such as the Internet, generally via an Internet Service Provider (ISP), not shown, the e-mail client and web browser allow data transmission and receipt over the TCP/IP network (2), using an appropriate protocol, such as SMTP for e-mail or HTTP for web pages.

The after sales support is provided by a medical web host (3) connected to the TCP/IP network (2), and comprising an e-mail server (3a) and web server (3b) to enable transmission and receipt of data over the network (2) using the appropriate protocol. The web server has access to a database (3c) storing web page data. On receipt of a request for a web page data file from the web browser (1b) of another computer over the TCP/IP network (2), the web server retrieves the requested file, or otherwise a default file, from the web page database and transmits it to the source address of the originating request. Thus, a user may browse or ‘visit’ the web site of the medical web host by downloading data representing a web page, stored in the web host's web page database (3c), to his computer (1) over the Internet (2), by entering the web host's URL into his computer, downloading the data, and displaying the data as a web page using his web browser program (1b).

The medical web host (3) further comprises an application server (3d) which functions to access databases (3f, 3g) for storage and retrieval of product data and user medication data. The application server (3d) is also linked to a product code database (3e) for storage and retrieval of product codes associated with medical products, whereby a product code received from a user's computer (1) by the medical web host (3) through the e-mail server (3a) in an e-mail message or through the web server (3b) as web page input data, or otherwise received by the application server (3d), may be compared against stored product codes in order to verify the received product code as authentic. Authentic product codes associated with medical products sold to users may be stored in the product code database (3e) by authorised personnel responsible for maintaining the medical support system.

The application server (3d) is also linked to a user contact database (3f) for storage and retrieval of user identifiers, such as passwords or login numbers, or contact addresses accompanying product codes received from the user's computer (1). User identifiers or contact addresses received by the application server (3d) may be compared against stored user identifiers or contact addresses in order to verify them as being valid.

The application server (3d) is arranged to output selected data to a user's computer (1) from one or more of the product information and user medication record databases (3g, 3h), conditional on a received product code being verified as authentic by comparison with codes stored in the product database (3e), and on being accompanied by a user identifier or contact address, as validated against those stored in contact database (3f). Thus, selected data, for example data requested by the user, can be transmitted to the user's computer through the e-mail server (3a) or web server (3b) over the TCP/IP network (2). The medical web host (3) further comprises a telecommunications interface (3i) linked to the application server (3d) via an identity encryption module (3k) to mask the user's telephone or pager identity, to enable data to be received and transmitted as SMS messages. Thus, selected data can be transmitted to a user's mobile telephone or pager (4) over a telecommunications link (5).

The application server (3d) is also linked to a medic access code database (3j) for storage and retrieval of access codes issued to registered medics, whereby an access code received from a medic's computer (6) by the medical web host (3) may be compared against stored access codes in order to verify the received access code as authentic. Authentic medic access codes issued to registered medics may be stored in the medic access code database (3j) by authorised personnel responsible for maintaining the medical support system.

The medic's computer (6) comprises an e-mail client (6a) and web browser (6b) to enable a medic to send and receive data over a TCP/IP network (2). The data is received and sent through the e-mail server (3a) in an e-mail message or through the web server (3b) as web page input data, or otherwise received by the application server (3d) of the medical web host (3).

The application server (3d) is arranged to output selected data to a medic's computer (6) from one or more of the product information and medication record databases (3g, 3h), conditional on a received medic access code being verified as authentic by comparison with codes stored in the medic access code database (3e). Thus, selected data, for example data requested by the medic, can be transmitted to the medic's computer through the e-mail server (3a) or web server (3b) over the TCP/IP network (2). In addition, selected data sent from the medic's computer (6) and received by the medical web host (3) may be stored in one or more of the databases (3g, 3h), or may be transmitted from the medical web host (3) to a selected user's computer (1). Thus, an authorised registered medic can update data stored in the databases (3g, 3h) accessible by the application server (3d) of the medical web host (3), and can provide data to selected users representing information relating to a particular medical product, for example in response to data received at the medic's computer (6) representing questions posed by users and sent to the medical web host (3).

Selected data, for example data representing answers to questions posed by users, can be transmitted from a medic's computer to selected users, either to a user's computer (1) through the e-mail server (3a) or web server (3b) over the TCP/IP network (2), or to a user's mobile telephone (4) through the telecommunications interface (3i) over a telecommunications link (5).

In a preferred medical support system, as shown in FIG. 2 with reference to steps S1-S19, a user, for example a patient, purchases a drug (S1). The drug is packaged, and has a registration code printed on the package. The code on the package corresponds to a code that is stored in a product code database by the drug manufacturer or after sales support provider.

The code is associated with the particular drug product that has been purchased so as to uniquely identify the individual packaged drug that the patient has purchased, so that the manufacturer or after sales support provider can ascertain what particular drug the patient has purchased, by cross checking the code against its records, i.e. the codes stored in the product code database. Alternatively, the code could be such as to identify the batch of drugs to which the patient's purchased drug belongs.

The packaging also has printed on it a URL for downloading a web page from a medical web host run by the after sales support provider. The patient reads off the URL from the packaging (S2), enters the URL into the input box prompt of a web browser program running in his personal computer, and instructs the web browser to output a request for the default or specified web page from the medical web host over the Internet (S3).

The web server of the medical web host receives the request for the default or specified web page, accesses a web page database where the data representing the requested web page is stored, retrieves the web page data and outputs the data over the Internet to the patient's computer. Thus, the patient has downloaded the web page. The patient's computer displays the page, including a prompt for entering a registration code (S4).

The patient reads the product code from the package and enters the code into his computer via the computer keyboard, as web page input data (S5), and instructs the web server to transmit the code via the Internet to the web server of the medical web host (S6).

On receipt of the code by the medical web host, the received code is extracted and codes stored in a product code database are accessed by the web host (S7). The web server of the web host also receives or accesses cookies stored on the user's computer, over the Internet or other network. The received code is compared against the stored codes (S8). If the received code corresponds to a valid stored product code, the received code is positively verified. However, if the received code is found not to correspond to a stored product code, whereby verification is negative, a web page asking the patient to re-enter a correct code is transmitted to the patient's computer (S9), and the operations S5 to S8 are repeated.

If the received code is found to be valid, the web host accesses a user identifier database and compares the received cookie data against the stored cookie data, to determine whether the received product code was accompanied by a valid cookie as user identifier (S10). If no valid cookie was received or accessed, for example if the user is new to the web host, a cookie is sent by the web host server to the user's computer and stored in the user's computer memory by the user's web browser software, as a user identifier. A corresponding user medication record is created and stored in a user medication record database (S11).

Information provided by the receipt of the product code in step S7 is used to update the user's medication record (S12). The web host may then retrieve data stored in one or both of a product database and user medication record database, linked to the application server, and output the retrieved data to the patient's computer (S16), whereupon the patient's computer displays the data to the patient (S17). Thus, the patient is granted access to product related data stored in one or more of the databases. In response to further prompts sent to the user by the web host, the user may enter further requested information as web page input data and transmit the information to the web host (S18). On receipt, the web host retrieves, updates and stores the user's medication record in the user medication record database (S19).

If desired, once a user has registered with a product code and user identifier, and the web host has stored user details in a corresponding medication record for the user (S12), the web host sends a web page to the user's computer inviting the user to provide an additional contact address for reminders and notifications. The user's web browser displays the web page, and the user enters a telephone number of an SMS-capable mobile telephone, or enters an e-mail address for the user, as web page input data and transmits the data to the web host (S14). The additional contact address may be for the patient being treated with or using the medical product, or for another user such as a carer or relative of the patient. On receipt, the web host extracts the telephone number or e-mail address from the received data and stores it as an additional contact address for the user in a contact address database (S15).

Subsequently, the web host may retrieve product related information relevant to the user from a product information database or from the user's medication record stored in the user medication record database, and transmit the information to the user's mobile telephone, via SMS messaging, or to the user's e-mail facility (S16). For example, a reminder message may be sent periodically to warn the patient or carer that their supply of a drug or other medical product will shortly run out, or will run past its expiry date, and to remind the user to purchase a fresh supply. In addition, or alternatively, periodic reminder messages may be sent to remind a user to comply with their treatment prescription. The user's mobile telephone or computer, as appropriate, receives the periodic notifications, and displays them to the patient or other user on the user's computer or mobile telephone (S17). If necessary, the user may respond by transmitting a return SMS or e-mail message containing requested information to the web host (S18), whereupon the web host receives the requested information and updates the user's medication record (S19).

In an alternative preferred medical support system, as shown in FIG. 3 with reference to steps S1a-S16a, a user, for example a patient, purchases a drug (S1a). The drug is packaged, and has a registration code printed on the package, corresponding to a code that is stored in a product code database by the drug manufacturer or after sales support provider. The packaging also has printed on it a telephone number for a medical web host run by the after sales support provider. The patient reads off the telephone number from the packaging (S2a), dials the number using their mobile or landline telephone, and makes a telephone connection with the web host (S3a).

The web host receives the telephone call from the user, and with it the number of the user's telephone is traced or otherwise obtained by the web host. The web host accesses a contact address database and compares the telephone number of the user with the stored contact addresses to determine whether the user's telephone number is already stored as a valid user identifier for the user (S4a). If no valid telephone number was received, for example if the user is new to the web host, the received telephone number is stored in a contact address database by the web host, as a user identifier for the user. A corresponding user medication record is created and stored in a user medication record database (S5a).

Once a telephone number has been stored as a contact address and user identifier for the user, the web host answers the user's telephone call with a voice message, preferably pre-recorded, requesting the user to enter a product code as tone dialled entries (S6a).

The patient reads the product code from the package and enters the code into his telephone keypad as tone dialled entries (S7a). Thus, the code is transmitted to the web host (S8a). Appropriate software or processing converts the tone dialled entries to electronic form for the web host.

On receipt of the code by the medical web host, the received code is extracted and codes stored in a product code database are accessed by the web host (S9a). The received code is compared against the stored codes (S10a). If the received code corresponds to a valid stored product code, the received code is positively verified. However, if the received code is found not to correspond to a stored product code, whereby verification is negative, a verbal message asking the user to re-enter a correct code is transmitted to the user's telephone (S11a), and the operations S7a to S10a are repeated. In a variant of the embodiment of FIG. 3, steps S6a to S11a, which relate to receipt and verification of a product code, precede step S5a relating to verification of the user's telephone number as user identifier. Thus, step S5a would immediately precede step 12a.

If the received code is found to be valid, the telephone connection may be terminated, and information provided by the receipt of the product code in step S9a is used to update the user's medication record (S12a). The web host may then retrieve data stored in one or both of a product database and user medication record database, linked to the application server, and output the retrieved data to the user's telephone (S13a) as an SMS or automated voice message, whereupon the user's telephone displays SMS message, or plays the voice message, to the user (S14a). Thus, the patient is granted access to product related data stored in one or more of the databases. In response to further prompts sent to the user by the web host, the user may enter further requested information as an SMS message, or as tone dialled entries as appropriate, and transmit the information to the web host (S15a). For example, the user may be invited to provide an additional contact address, as described for FIG. 2 above. On receipt, the web host retrieves, updates and stores the user's medication record in the user medication record database (S16a).

Subsequently, the web host may retrieve product related information relevant to the user from a product information database or from the user's medication record stored in the user medication record database, and periodically transmit the information to the user's mobile telephone, via SMS messaging (S13a). The user's mobile telephone receives the periodic notifications, and displays them to the patient or other user on the user's mobile telephone (S14a). If necessary, the user may respond by transmitting a return SMS message containing requested information to the web host (S15a), whereupon the web host receives the requested information and updates the user's medication record (16a).

As shown in FIG. 4, with reference to steps S20-S35, the medical web host is additionally configured to receive an access code from a medic. The medic will have registered with the host (S20), and been provided with a personal access code stored in an access database linked to the medical web host (S21). The medic may transmit the access code to the medical web host over the Internet, for example by means as explained above in relation to the patient and other users (S22-S26). On receiving the code over the Internet (S27), the medical web host compares the received access code with access codes stored in an access database to determine whether the received access code is valid (S28). If the received code is verified as valid, so as to authenticate the sender as a registered medic, access to information from the medical web host, for example product information and/or user medication record information, is granted to the medic (S30). This information is transmitted to the medic's computer and displayed to the medic (S31). If the received access code does not correspond to a valid access code, the web host transmits to the medic's computer a web page asking the medic to re-enter a correct access code (S29), and the operations S24 to S28 are repeated.

The medical web host is further configured to receive information from the medic and store the received information in a database linked to the medical web host, for example in a product information database, patient records database and/or medical information database. Thus, a medic can update the information stored by the medical web host in one or more databases (S33), or can make available, direct or restrict selected information to relevant users of a relevant medical product (S34, S35), by entering data into his computer and instructing his computer to transmit the data to the medical web host for storage in one or more of the databases (S32).

1. A method of providing medical after sales support to a patient or other user associated with a patient having a packaged medical product, the packaged medical product having a code identifying the product, the method comprising:
receiving a product code and a user identifier/contact address at a medical information computer over a communications link from a user;
verifying that the received product code corresponds to a valid product code stored in a product code database;
verifying that the received user identifier/contact address corresponds to a valid user identifier/contact address stored in a user identifier/contact address database;
retrieving stored information related to the packaged medical product identified by the product code from a user medication record database or product information database, upon positive verification; and
outputting the retrieved information related to the packaged medical product over a communications link to the user identifier/contact address, wherein the user remains anonymous to the medical information computer.

2. A method according to claim 1, wherein the product code is a code that identifies a group of identical packaged medical products, and information related to the group of products is retrieved from a product information database and outputted to the user identifier/contact address.

3. A method according to claim 2, wherein the group of identical packaged medical products is a batch or other plurality of identical packaged pharmaceutical drugs.

4. A method according to claim 1, wherein the product code is a code that uniquely identifies an individual packaged medical product, and information related to the individual product is retrieved from a user medication record database or product information database and outputted to the user identifier/contact address.

5. A method according to claim 4, wherein the uniquely identified individual packaged medical product is one of a plurality of identical, individually packaged doses of a pharmaceutical drug, and information related to the individually packaged dose is retrieved from a user medication record database and outputted to the user identifier/contact address.

6. A method according to claim 1, wherein the stored user identifier/contact address is an IP address and the product code is received as web page input data.

7. A method according to claim 6, wherein the retrieved information is outputted as a web page or other displayable data file.

8. A method according to claim 6, further comprising receiving cookie information, a login number or a password over a communications link from the user, and verifying that the received cookie information, login number or password corresponds to valid cookie information, login number or password assigned to the IP address and stored in the user identifier/contact address database.

9. A method according to claim 1, wherein the stored user identifier/contact address is a telephone number for a mobile telephone having SMS capability, and the product code is received as tone dialed telephone entries, voice-recognized telephone entries or an SMS message.

10. A method according to claim 9, further comprising encrypting the telephone number.

11. A method according to claim 9, wherein the retrieved information is outputted as an SMS message or automated voice message.

12. A method according to claim 1, wherein the stored user identifier/contact address is an e-mail address, and the product code is received as an e-mail message.

13. A method according to claim 12, wherein the retrieved information is outputted as an e-mail message.

14. A method according to claim 1, further comprising storing information related to the user's use of the medical product identified by the product code in a user medication record database, upon positive verification.

15. A method according to claim 1, comprising retrieving stored information related to the user's use of the medical product identified by the product code from a user medication record database and outputting the retrieved information to a stored user identifier/contact address.

16. A method according to claim 1, wherein the retrieved and outputted information is specific to a prescribed course of treatment with the medical product identified by the product code.

17. A method according to claim 16, wherein the retrieved and outputted information is a reminder message for the user for complying with the prescribed course of treatment.

18. A method according to claim 16, wherein the retrieved and outputted information is a reminder message for the user for renewing stock of the medical product.

19. A method according to claim 16, wherein the retrieved and outputted information provides guidance and conformance information to assist the user in producing a provable record of compliance with the prescribed course of treatment.

20. A method according to claim 1, wherein the communications link comprises the Internet.

21. A method according to claim 1, wherein the communications link comprises a wireless telecommunications link.

22. A method according to claim 1 further comprising:
receiving an access code at the medical information computer over a communications link from a medic's computer;
verifying that the received access code corresponds to a valid access code stored in an access code database;
retrieving stored information from a user medication record database or product information database, upon positive verification; and
outputting the retrieved information over a communications link to the medic's computer.

23. A method according to claim 22, further comprising receiving information from the medic's computer and storing the received information in one or more of a patient medical record database, product information database, and user medication record database.

24. A method according to claim 22, further comprising receiving information received from the medic's computer and outputting the received information to a user identifier/contact address stored in the user identifier/contact address database.

25. An apparatus for providing medical after sales support to a patient or other user associated with a patient having a packaged medical product with a code identifying the product, the apparatus comprising:
first receiving means for receiving a product code at a medical information computer over a communications link from a user;
second receiving means for receiving a user identifier/contact address at the medical information computer over a communications link from the user;
first verifying means for verifying that the received product code corresponds to a valid product code stored in a product code database;
second verifying means for verifying that the received user identifier/contact address corresponds to a valid user identifier/contact address stored in a user identifier/contact address database;
retrieving means for retrieving stored information related to the packaged medical product identified by the product code from a user medication record database or product information database, upon positive verification; and
outputting means for outputting the retrieved information over a communications link to the user identifier/contact address, wherein the user remains anonymous to the medical information computer.

26. An apparatus according to claim 25, further comprising one or more of a product code database, user identifier/contact address database, user medication record database and product information database.

27. An apparatus according to claim 25, wherein the first receiving means is arranged for receiving the product code as web page input data and the second receiving means is arranged for receiving an IP address as the user identifier/contact address.

28. An apparatus according to claim 27, wherein the outputting means is arranged for outputting the retrieved information as a web page or other displayable data file.

29. An apparatus according to claim 27, further comprising receiving means for receiving cookie information, a login number or a password over a communications link from the user, and further comprising verifying means for verifying that the received cookie information, login number or password corresponds to valid cookie information, login number or password assigned to the IP address and stored in the user identifier/contact address database.

30. An apparatus according to claim 25, wherein the first receiving means is arranged for receiving the product code as tone dialed telephone entries, voice-recognized telephone entries or an SMS message, and the second receiving means is arranged for receiving a telephone number of a mobile telephone having SMS capability as the user identifier/contact address.

31. An apparatus according to claim 30, wherein the outputting means is arranged for outputting the retrieved information as an SMS message or automated voice message.

32. An apparatus according to claim 25, wherein the first receiving means is arranged for receiving the product code as an e-mail message, and the second receiving means is arranged for receiving an e-mail address as the user identifier/contact address.

33. An apparatus according to claim 32, wherein the outputting means is arranged for outputting the retrieved information as an e-mail message.

34. An apparatus according to claim 25, further comprising storing means for storing information related to the user's use of the medical product identified by the product code in a user medication record database, upon positive verification.

35. An apparatus according to claim 34, wherein the storing means further comprises record assembly means for assembling information representing record fragments and received through different access channels into a composite medication record.

36. An apparatus according to claim 35, wherein the storage means stores each record fragment associated with its access channel, whereby stored information representing a user medication record or record fragment is retrieved and outputted to the received user identifier/contact address only after receipt of positive verification through the access channel associated with the record fragment.

37. An apparatus according to claim 25, wherein the product code is a code that identifies a group of identical packaged medical products, and the outputting means is arranged for outputting retrieved information related to the group of products from a product information database to the user identifier/contact address.

38. An apparatus according to claim 25, wherein the product code is a code that uniquely identifies an individual packaged medical product, and the outputting means is arranged for outputting retrieved information related to the individual product from a user medication record database or product information database to the user identifier/contact address.

39. An apparatus according to claim 38, wherein the uniquely identified individual packaged medical product is one of a plurality of identical, individually packaged doses of a pharmaceutical drug, and the outputting means is arranged for outputting retrieved information related to an individually packaged dose from a user medication record database to the user identifier/contact address.

40. An apparatus according to claim 25, further comprising:
receiving means for receiving an access code at a medical information computer over a communications link from a medic's computer;
verifying means for verifying that the received access code corresponds to a valid access code stored in an access code database;
retrieving means for retrieving stored information from a user medication record database or product information database, upon positive verification; and
outputting means for outputting the retrieved information over a communications link to the medic's computer.

41. An apparatus according to claim 40, further comprising receiving means for receiving information from the medic's computer and storing means for storing the received information in one or more of a patient medical record database, product information database, and user medication record database.

42. An apparatus according to claim 40, further comprising receiving means for outputting information from the medic's computer and outputting means for outputting the received information to a user identifier/contact address stored in the user identifier/contact address database.

43. An apparatus according to claim 25, wherein the receiving means and the outputting means are arranged for receiving and outputting information via the Internet.

44. An apparatus according to claim 25, wherein the receiving means and the outputting means are arranged for receiving and outputting information via a wireless telecommunications link.

45. A computer system for providing after sales support to a patient or other user associated with a patient having a packaged medical product with a code identifying the product, the computer system comprising:
a memory storing program code for controlling a processor; and a processor for implementing the program code stored in the memory,
wherein the stored program code comprises code for controlling the processor to:
receive a product code and a user identifier/contact address over a communications link from a user;
verify that the received product code corresponds to a valid product code stored in a product code database;
verify that the received user identifier/contact address corresponds to a valid user identifier/contact address stored in a user identifier/contact address database;
retrieve stored information related to the packaged medical product identified by the product code from a user medication record database or product information database, upon positive verification; and
output the retrieved information related to the packaged medical product over a communications link to the user identifier/contact address.

46. A computer system according to claim 45, wherein the stored program code controls the processor to: receive the product code as web page input data; and receive an IP address as the user identifier/contact address.

47. A computer system according to claim 46, wherein the stored program code controls the processor to: output the retrieved information as a web page or other displayable data file.

48. A computer system according to claim 46, wherein the stored program code further controls the processor to:
receive cookie information, a login number or a password over a communications link from the user; and
verify that the received cookie information, login number or password corresponds to valid cookie information, login number or password assigned to the IP address and stored in the user identifier/contact address database.

49. A computer system according to claim 45, wherein the stored program code controls the processor to:
receive the product code as tone dialed telephone entries, voice-recognized telephone entries or an SMS message; and receive a telephone number of a mobile telephone having SMS capability as the user identifier/contact address.

50. A computer system according to claim 49, wherein the stored program code controls the processor to:
output the retrieved information as an SMS message or an automated voice message.

51. A computer system according to claim 45, wherein the stored program code controls the processor to:
receive the product code as an e-mail message, and receive an e-mail address as the user identifier/contact address.

52. A computer system according to claim 51, wherein the stored program code controls the processor to:
output the retrieved information as an e-mail message.

53. A computer system according to claim 45, wherein the stored program code controls the processor to:
periodically output retrieved information to the user identifier/contact address.

54. A computer system according to claim 45, wherein the product code is a code that identifies a group of identical packaged medical products, and the stored program code controls the processor to output retrieved information related to the group of products from a product information database to the user identifier/contact address.

55. A computer system according to claim 45, wherein the product code is a code that uniquely identifies an individual packaged medical product, and the stored program code controls the processor to output retrieved information related to the individual product from a user medication record database or product information database to the user identifier/contact address.

56. A computer system according to claim 55, wherein the uniquely identified individual packaged medical product is one of a plurality of identical, individually packaged doses of a pharmaceutical drug, and the stored program code controls the processor to output retrieved information related to the individually packaged dose from the user medication record database to the user identifier/contact address.

57. A computer system according to claim 45, wherein the stored program code further controls the processor to: store information, related to the user's use of the medical product identified by the product code, in the user medication record database, upon positive verification.

58. A computer system according to claim 45, wherein the stored program code controls the processor to: output information, related to the user's use of the medical product identified by the product code, from the user medication record database to a stored user identifier/contact address.

59. A computer system according to claim 45, wherein the stored program code controls the processor to:
output information specific to a prescribed course of treatment with the medical product identified by the product code.

60. A computer system according to claim 59, wherein the stored program code controls the processor to:
output a reminder message for the user for complying with the prescribed course of treatment with the medical product.

61. A computer system according to claim 59, wherein the stored program code controls the processor to:
output a reminder message for the user for renewing stock of the medical product.

62. A computer system according to claim 45, wherein the stored program code further controls the processor to:
receive an access code over a communications link from a medic's computer;
verify that the received access code corresponds to a valid access code stored in an access code database;
retrieve information stored in a user medication record database or product information database, upon positive verification; and
output the retrieved information from the user medication record database or product information database over a communications link to the medic's computer.

63. A computer system according to claim 62, wherein the stored program code further controls the processor to:
receive information from the medic's computer; and
store the received information in one or more of a patient medical record database, product information database, and user medication record database.

64. A computer system according to claim 62, wherein the stored program code further controls the processor to:
receive information from the medic's computer; and
output the received information to a user identifier/contact address stored in the user identifier/contact address database.

65. A carrier medium carrying computer readable code for controlling a computer to carry out the method of claim 1.
